(19) United States
(12) Patent Application Publication
(10) Pub. No.: US 2012/0066924 A1
(43) Pub. Date: Mar. 22, 2012

(54) NUTRITION-ENRICHED GAIN MANUFACTURING APPARATUS AND GAIN DRYING FACILITY INCLUDING THE SAME

(76) Inventors: Toshiharu Ando, Yoro-gun (JP); Tsuyako Ando, Yoro-gun (JP)

(21) Appl. No.: 13/309,002

(22) Filed: Dec. 1, 2011

Related U.S. Application Data
(63) Continuation of application No. PCT/JP2009/061351, filed on Jun. 23, 2009.

(51) Int. Cl. F26B 19/00; A23B 9/02

(52) U.S. Cl. 34/90; 99/483

(57) ABSTRACT

A nutrition-enriched grain manufacturing apparatus includes a heating processing portion including a far infrared ray radiator which emits far infrared rays to a flow-down path along which grain flows down, an upper rotary valve device and a lower rotary valve device which adjust a flow rate of the grain, an accumulation portion which accumulates the grain, a lower screw conveyer and a bucket conveyer which transport the grain which has flown down from the heating processing portion to the discharge portion to the accumulation portion, a moisture meter which measures a moisture content of the grain, a grain temperature sensor which measures a grain temperature, a main controller which controls output from a burner and operations of the upper rotary valve device and the lower rotary valve device such that the grain temperature is a predetermined grain temperature.

This application is a continuation of International Application No. PCT/JP2009/061351 filed on Jun. 23, 2009, of which full contents are incorporated herein by reference.

### BACKGROUND OF THE INVENTION

1. Field of the Invention

The present invention relates to a manufacturing apparatus for manufacturing nutrition-enriched grain in which a content of gamma aminobutyric acid in grain is enriched and a grain drying facility including the same, such as a country elevator.

2. Description of Related Art

It is said that taking gamma aminobutyric acid is effective in preventing hypertension and improving bloodstream. Conventionally, various foods which abundantly contain the gamma aminobutyric acid have been generally manufactured. It is well-known that if grain is made to germinate, a content of the gamma aminobutyric acid is increased. It is also known that the gamma aminobutyric acid is increased in a surface part mainly including germ, integument, and the like (for example, germ and bran layer in a case of brown rice) of the grain which has been made to germinate (hereinafter, referred to as germinated grain). Therefore, the germinated grain is used for food in a state where the germ and the integument are left.

Further, a technique of manufacturing rice having increased functional ingredients such as the gamma aminobutyric acid in an endosperm part by sluggishly hydrating brown rice and conditioning at a normal temperature without soaking has been also studied (see Patent Document 1; Japanese Patent Application Laid-open No. 2005-52073). The brown rice having the increased functional ingredients by using the technique disclosed in Japanese Patent Application Laid-open No. 2005-52073 abundantly contains the gamma aminobutyric acid.

On the other hand, the present applicant proposes a nutrition-enriched rice manufacturing method of significantly enriching the gamma aminobutyric acid in the endosperm part of unhulled rice by performing a nutrition enriching processing. The nutrition enriching processing is a processing of heating the unhulled rice having a predetermined average moisture content to a predetermined temperature, and then, retaining heat for a predetermined time. The nutrition-enriched rice manufacturing method is not published at the time of application of the present application.

In rice obtained by using the technique, the gamma aminobutyric acid is enriched in the endosperm part. Therefore, polished rice obtained by polishing the rice also contains the gamma aminobutyric acid abundantly.
[Patent Document 1] Japanese Patent Application Laid-open No. 2005-52073

With the technique disclosed in Japanese Patent Application Laid-open No. 2005-52073, grain having an increased content of the gamma aminobutyric acid can be manufactured without soaking. However, a complicated system for hydration and conditioning has been required in the technique. Accordingly, time and effort have been required for operation and maintenance in addition to increased system cost.

In addition, conditions of hydration and conditioning have been required to be controlled by closely monitoring change of the moisture content of the grain for a long time during the nutrition enriching processing. As estimating based on the disclosure in Japanese Patent Application Laid-open No. 2005-52073, it takes 12 to 22 hours from the start of the hydration onto a raw material to the end of the conditioning. Therefore, speeding-up of a manufacturing process has been demanded.

Further, in the technique described in Japanese Patent Application Laid-open No. 2005-52073, since it takes a long time for the hydration processing and the conditioning at a normal temperature, bacteria is easily propagated. As a result, there has been a risk that an unusual odor is generated on obtained rice as product.

On the other hand, as for the above nutrition-enriched rice manufacturing method proposed by the present applicant, an apparatus which can mass produce grain (unhulled rice) having enriched gamma aminobutyric acid by applying the method has been desired.

### SUMMARY OF THE INVENTION

In consideration of the above circumstances, an object of the invention is to provide a nutrition-enriched grain manufacturing apparatus which can enrich a content of gamma aminobutyric acid in grain easily and efficiently with a simple system and a grain drying facility which can mass produce nutrition-enriched grain, such as a country elevator.

A nutrition-enriched grain manufacturing apparatus according to an aspect of the invention includes heating means for heating grain, a grain temperature sensor which measures a grain temperature of the grain, and heating control means for controlling the heating means such that the grain temperature is a predetermined temperature set to be equal to or higher than 52° C. and equal to or lower than 80°.

An expression “grain” indicates grain in a broad sense, which includes beans in addition to cereals.

Further, the heating means includes not only a heat source which simply emits heat but also a combination in which various members and devices are combined with a heat source. That is to say, the heating means may be a member which can adjust a heating state by a configuration other than a heat source such as a member which can change a distance between grain to be heated and a heat source by moving the grain and a member which can change a movement speed of the grain. The heating control means controls operations of various configurations included in such heating means.

As both of the grain temperature sensor and the heating control means, ordinary products can be used. A known technique such as a far infrared ray radiator can be also used as the heating means. The nutrition-enriched grain manufacturing apparatus according to the aspect of the invention does not necessarily require a water supply/drainage system unlike the conventional technique of increasing a content of gamma aminobutyric acid in the grain. Therefore, the nutrition-enriched grain manufacturing apparatus according to the aspect of the invention has a simple configuration.

With the nutrition-enriched grain manufacturing apparatus according to the aspect of the invention, the heating control means controls the heating means based on a measured grain temperature to increase the grain temperature to a predetermined temperature of 52 to 80° C. With this, a content of gamma aminobutyric acid is enriched in a site of the grain, which contains an endosperm part. Further, since the heating control means controls the heating means based on the grain temperature, the grain temperature during the nutrition enriching processing is stabilized at the predetermined temperature and the content of the gamma aminobutyric acid in the manufactured grain is suppressed from being varied.

A required time for the nutrition enriching processing is different depending on grain (wheat, corn, unhulled rice, soy, or the like). Further, an appropriate processing time changes depending on a moisture content of the grain. When the moisture content is higher, it is sufficient that the processing time is relatively short since an effect of the nutrition enriching processing is enhanced.

In the conventional technique of increasing the content of the gamma aminobutyric acid by making the grain absorb water to prompt the grain to germinate, a long processing time of 12 to 72 hours has been required. In contrast, in the nutrition-enriched grain manufacturing apparatus according to the aspect of the invention, the grain is not necessarily required to absorb water and the content of gamma aminobutyric acid is enriched by heating, thereby making the required time shorter than that in the conventional technique. As an example, when unhulled rice is used as a raw material, a required time for increasing the content of the gamma aminobutyric acid to equal to or larger than 8 mg/100 g is 3 minutes at the shortest. Further, the content of the gamma aminobutyric acid becomes larger than 12 mg/100 g for a processing time of 10 minutes and the content of the gamma aminobutyric acid becomes approximately 20 mg/100 g for a processing time of 60 minutes. The required time for the nutrition enriching processing changes depending on a breed of the grain. However, the contents of the gamma aminobutyric acid in grains other than the unhulled rice can be enriched with a processing time which is substantially equivalent to that in the case of the unhulled rice.

It is to be noted that grain as a raw material having a high moisture content can be easily obtained by harvesting grain after rainfall or the like. Further, in a case of grain having a low moisture content, if the grain is soaked in water so as to increase the moisture content thereof, the grain can be made to be suitable for the nutrition enriching processing. At this time, it is more preferable that the grain be soaked in water at a temperature deviated from a temperature range in which the grain can germinate since consumption of nutrition for the germination action is prevented. For example, in the case of the unhulled rice, the temperature range in which the unhulled rice can germinate is approximately 10 to 45° C. Therefore, if the unhulled rice is soaked in cool water at equal to or lower than 10° C. or in hot water at equal to or higher than 45° C., the moisture content of the unhulled rice can be increased without making the unhulled rice germinate. In this manner, the unhulled rice can be made to be grain which is suitable as a raw material used in the nutrition-enriched grain manufacturing apparatus according to the aspect of the invention.

Further, it is preferable that the nutrition-enriched grain manufacturing apparatus according to the aspect of the invention further include storage means for storing a predetermined reference moisture content, a moisture meter which measures a moisture content of the grain before the nutrition enriching processing, warning means for issuing warning indicating that the moisture content of the grain is lower, and warning control means for comparing the measured moisture content and the reference moisture content with each other and making the warning means issue the warning when the moisture content is lower than the reference moisture content.

Here, various methods such as a hard disk, a memory card, and a ROM can be used as the storage means. Further, the storage means may be configured as a one-chip IC together with the warning control means. The warning control means may be integrated with the heating control means. As the warning means, a member which visually indicates the warning on a liquid crystal screen or an LED, a member which indicates the warning with audio such as a speaker, and the like can be exemplified.

The reference moisture content is different depending on a breed of grain. In cases of unhulled rice and brown rice as examples, the reference moisture content can be set in a range of an average moisture content of 20 to 35%. In the same manner, the reference moisture content can be set in a range of the average moisture content of 25 to 40% in a case of wheat, 30 to 80% in a case of corn, and 25 to 50% in a case of soy. It is desirable that the grain as a raw material is in a high-moisture state. Therefore, a range in which the reference moisture content is set is preferably 23 to 32% in the cases of unhulled rice and brown rice, 30 to 35% in the case of wheat, 35 to 80% in the case of corn, and 30 to 50% in the case of soy. The reference moisture content is appropriately set depending on the breed of the grain.

A preferable processing time in the nutrition enriching processing of the grain changes depending on the moisture content of the raw material. Therefore, a heating state of the grain has been required to be adjusted based on the moisture content of the raw material, conventionally. In addition, whether the moisture content is appropriate or not cannot be judged from external appearance. Therefore, the moisture content has been required to be measured by a moisture meter by taking out a sample. However, when a large amount of grain is processed, there has arisen a risk that the moisture content of the raw material is not even or the moisture content changes during the processing.

In contrast thereto, with the constitution of the invention, when the moisture content of the grain is lower than the predetermined reference moisture content, a warning is displayed to invite a user to pay attention thereto. Therefore, manufacturing of a product having a low content of the gamma aminobutyric acid due to shortage of the moisture content of the grain is prevented. It is needless to say that when the warning is displayed, the nutrition enriching processing may be interrupted.

Further, it is preferable that the nutrition-enriched grain manufacturing apparatus according to the aspect of the invention further include an accumulation portion which accumulates the heated grain.

After the grain has been heated to a predetermined temperature by the heating means, the grain is accumulated in the accumulation portion and the nutrition enriching processing thereon is made to proceed by residual heat so that energy efficiency can be improved. At this time, if the accumulation portion has a heat retention function, heat loss is much smaller so that the nutrition enriching processing proceeds with the residual heat for a longer time. With this, a time during which the heating means is used is made shorter and the grain to be heated per unit time is increased, thereby improving manufacturing efficiency.

Further, it is preferable that the nutrition-enriched grain manufacturing apparatus according to the aspect of the invention further include storage means for storing a predetermined reference moisture content, a moisture meter which measures a moisture content of the grain before the nutrition enriching processing, warning means for issuing warning indicating that the moisture content of the grain is lower, heating means for heating grain having germ, an accumulation portion which accumulates the heated grain and a grain temperature sensor which is arranged on the accumulation portion and measures a grain temperature of the grain, transfer means for moving the heated grain to the accumulation portion, drying means for drying the grain which has been accumulated in the accumulation portion, and main control means for controlling operations of the warning means, the heating means, the transfer means and the drying means, wherein the main control means controls a moisture content checking processing of comparing the measured moisture content and the reference moisture content with each other and making the warning means issue the warning when the moisture content is lower than the reference moisture content, controls the heating means to heat the grain such that the grain temperature is a predetermined temperature set to be equal to or higher than 52° C. and equal to or lower than 80° C., moves the heated grain to the accumulation portion and makes the grain be accumulated in the accumulation portion for a predetermined time so as to control a nutrition enriching processing of enriching a content of gamma aminobutyric acid in the grain having the germ, and controls a dry processing of drying the grain which has been subjected to the nutrition enriching processing by the drying means.

With the nutrition-enriched grain manufacturing apparatus having the constitution, the main control means controls the heating means to heat the grain to the predetermined temperature and controls the transfer means to move the grain to the accumulation portion and accumulate the grain therein so as to perform the nutrition enriching processing. Further, the main control means controls the drying means to dry the grain which has been nutrition-enriched. The grain which has been subjected to the nutrition enriching processing is dried in a continuous process without transferring the grain to a grain dryer. Therefore, time and effort required for an operator is eliminated so as to make an operation time shorter.

Further, the heating means and the drying means share the accumulation portion so as to save a space. Further, hot air drying at a temperature of approximately 30 to 40° C. is generally performed for drying the grain. In the constitution, one heat source can serve as a heat source of the heating means and a heat source of the drying means so that a space can be further saved. For example, heating in the nutrition enriching processing and heating for drying may be performed by one far infrared ray radiator.

As the transfer means, various configurations can be employed and a configuration thereof is not particularly limited. As examples of the transfer means, a belt conveyer, a screw conveyer, a bucket conveyer, and the like can be exemplified. Further, a configuration in which the grain is moved by falling or dropping with a gravity force may be employed. In addition, the nutrition enriching processing may be performed by returning the grain which has been accumulated in the accumulation portion to the heating processing portion again and increasing a temperature thereof iteratively in a stepwise manner.

A grain drying facility according to another aspect of the invention includes a grain dryer which dries arrived grain and the above nutrition-enriched grain manufacturing apparatus.

In general, the harvested grain is arrived at a grain drying facility such as a country elevator soon after being harvested and is dried until a moisture content of the grain becomes a moisture content suitable for reserving. At the proper time of harvesting, the arrival of grain at the grain drying facility is concentrated. Therefore, grain waiting for the dry processing is temporarily accumulated in an undried state. In other words, in the grain drying facility at the proper time of harvesting, undried grain waiting for the dry processing is collected. With the grain drying facility according to the aspect of the invention, the nutrition enriching processing is performed on the undried grain at site. Thereafter, the grain is dried in the grain dryer so as to be reserved, thereby effectively manufacturing the nutrition-enriched grain.

Further, with this constitution, whether the nutrition enriching processing of enriching the content of the gamma aminobutyric acid is performed or not can be selected before the grain is dried. Therefore, an appropriate method can be selected depending on a usage condition of each system in the grain drying facility. For example, when there is no enough dry processing capability of the grain dryer, the nutrition enriching processing can be performed on the grain waiting for being dried. When there is no enough processing capability of the nutrition-enriched grain manufacturing apparatus, the grain may be dried without performing the nutrition enriching processing thereon.

Further, accompanying systems such as a fuel supply system in the grain drying facility can be shared by the nutrition-enriched grain manufacturing apparatus. Therefore, in this case, system cost and running cost are reduced in comparison with a case where the grain drying facility and the nutrition-enriched grain manufacturing facility are separately provided.

It is difficult to distinguish between nutrition-enriched grain and grain which has not been subjected to the nutrition enriching processing based on external appearances. Therefore, if grain is transferred between a plurality of facilities, the grain is delivered and received in the middle of the transferring. This arises a risk that nutrition-enriched grain and other grains are mixed. In order to solve this problem, with the grain drying facility according to the aspect of the invention, nutrition enrichment and drying of grain are consistently performed in the grain drying facility. This prevents the nutrition-enriched grain and other grains from being mixed during the transferring so as to make manufacturing management easy.

### EFFECT OF THE INVENTION

As described above, according to the aspect of the invention, a nutrition-enriched grain manufacturing apparatus which can enrich a content of gamma aminobutyric acid in grain easily and efficiently with a simple system which does not require a water supply/drainage system without requesting a user to finely manage and a grain drying facility including the same, such as a country elevator, can be provided.

### BRIEF DESCRIPTION OF THE DRAWINGS

FIG. 1 is a schematic cross-sectional view illustrating a configuration of a nutrition-enriched rice manufacturing apparatus in a width direction thereof.

FIG. 2 is a schematic cross-sectional view illustrating the configuration of the nutrition-enriched rice manufacturing apparatus in a lengthwise direction.

FIG. 3 is a block diagram illustrating the nutrition-enriched rice manufacturing apparatus.

FIG. 4 is a flowchart illustrating flow of control of a nutrition enriching processing.

FIG. 5 is a descriptive view illustrating flow of the nutrition enriching processing.

FIG. 6 is a descriptive view schematically illustrating a configuration of a nutrition-enriched rice manufacturing apparatus according to a different embodiment.

FIG. 7 is a descriptive view schematically illustrating a configuration of a nutrition-enriched rice manufacturing apparatus according to a still different embodiment.

FIG. 8 is a descriptive view for explaining a configuration of a grain drying facility.

### DETAILED DESCRIPTION OF THE EMBODIMENT

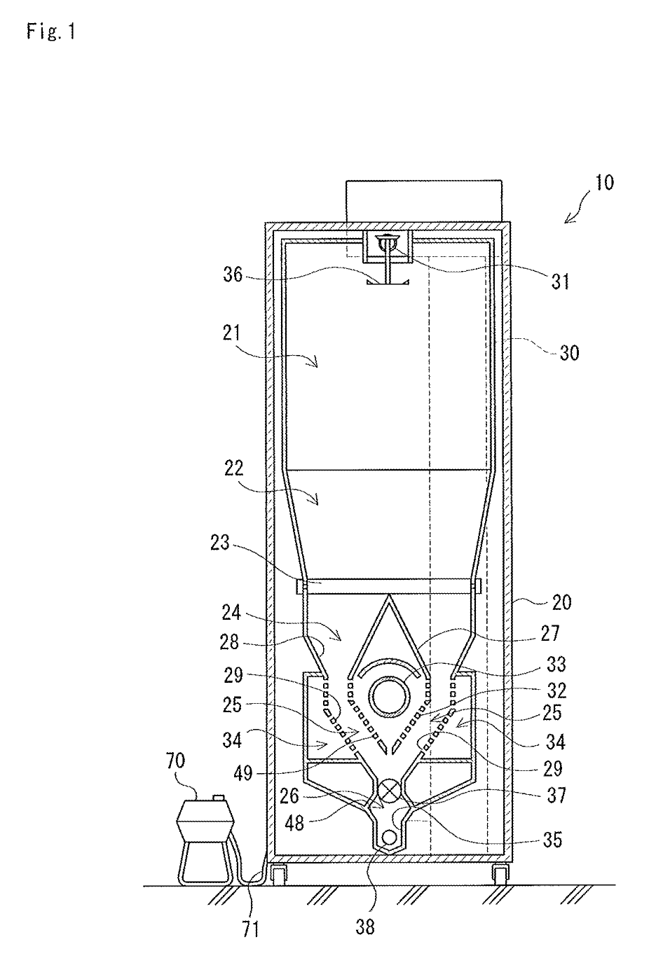

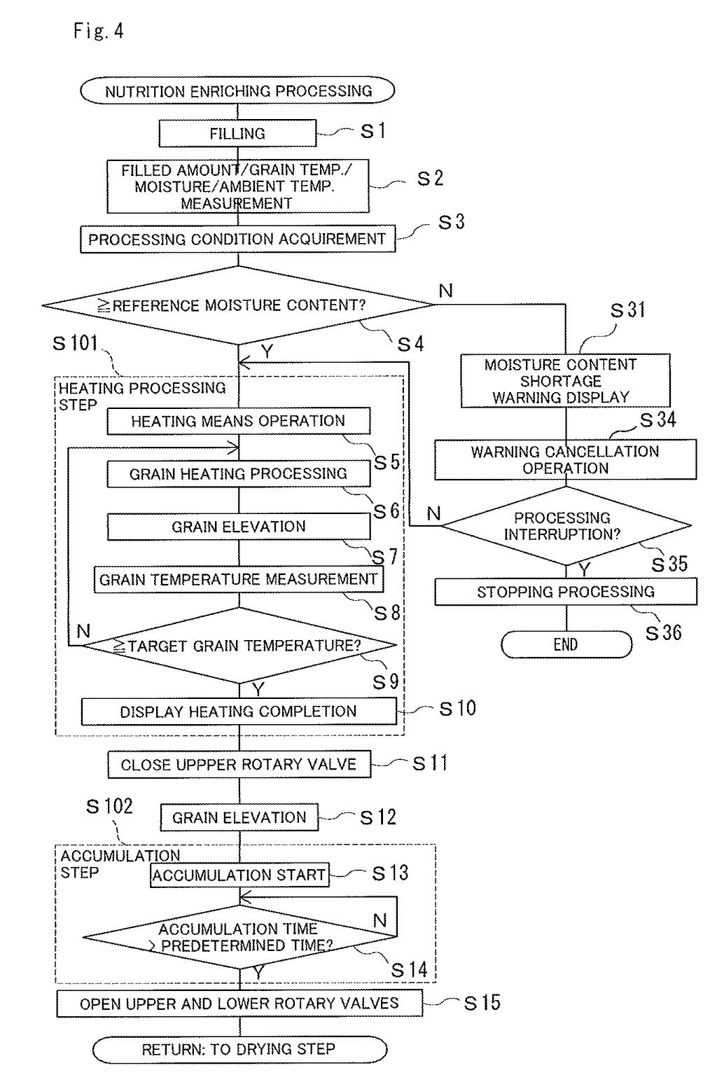

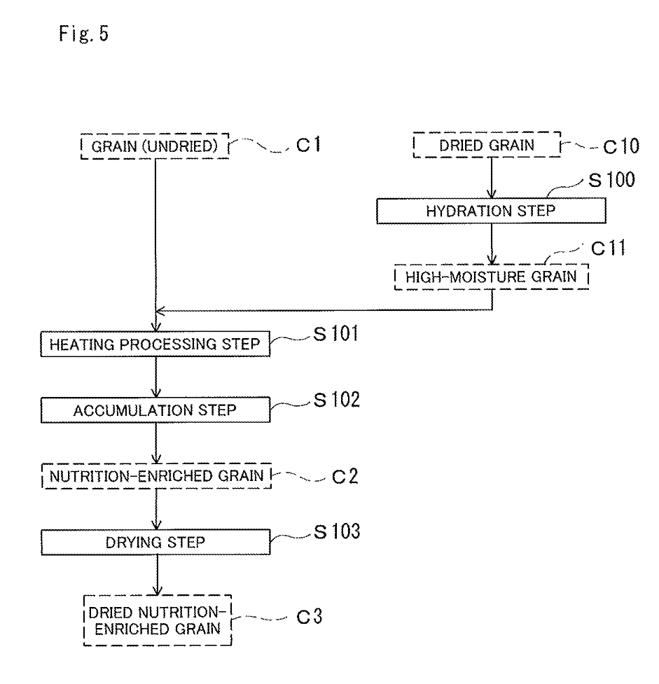

Hereinafter, a nutrition-enriched rice manufacturing apparatus 10 is described with reference to FIG. 1 to FIG. 5. It is to be noted that a mechanical configuration of the nutrition-enriched rice manufacturing apparatus 10 is a reference example and control flow to be described with reference to FIG. 4 and flow of a nutrition enriching processing to be described with reference to FIG. 5 are one embodiment of the invention.

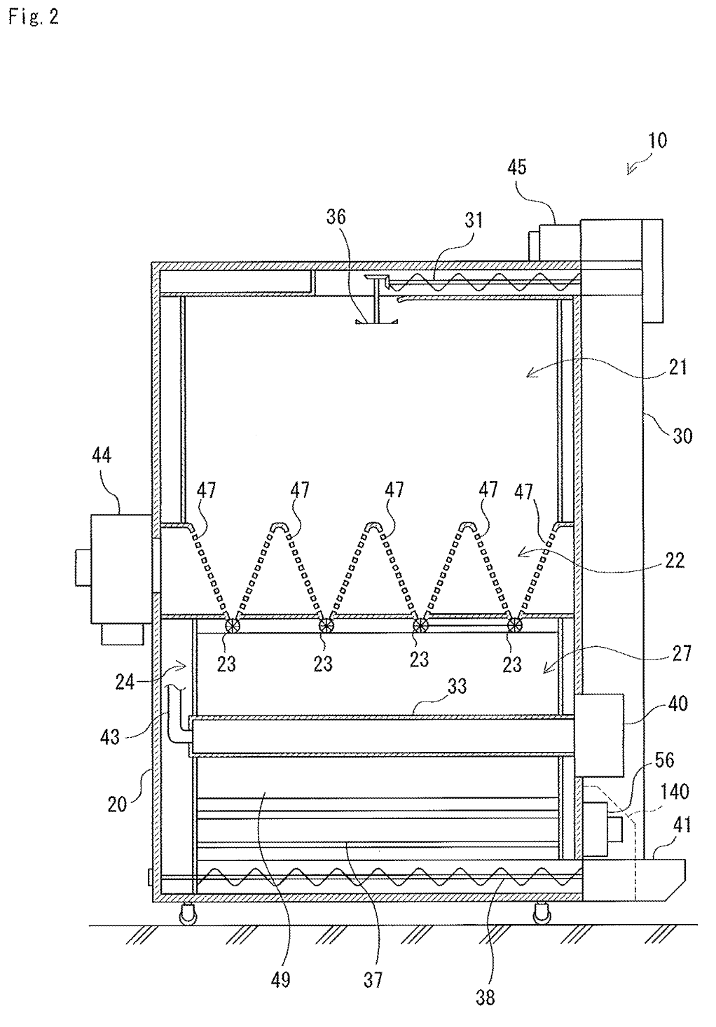

As illustrated in FIG. 1 and FIG. 2, the nutrition-enriched grain manufacturing apparatus 10 has a schematic configuration like a conventional grain dryer. An accumulation portion 21, a heating processing portion 24, and a discharge portion 26 are provided in a casing 20 having a substantially box shape in this order from the upper side to the lower side. The accumulation portion 21, the heating processing portion 24, and the discharge portion 26 are thermally insulated from an outer plate of the casing 20 with rigid urethane. A bucket conveyer 30 attached to an outer side of the casing 20 transports grain which has been put in a charge hopper 41 to the upper side and puts the grain in the accumulation portion 21 at an upper portion through an upper screw conveyer 31. A lower screw conveyer 38 is provided in a discharge pit 35 at a bottom of the discharge portion 26 provided at a lowermost portion so that the grain in the discharge portion 26 is fed to the bucket conveyer 30 provided at the outer side of the casing 20 and is returned to the accumulation portion 21 so as to be circulated. Note that the bucket conveyer 30, the upper screw conveyer 31, and the lower screw conveyer 38 correspond to transfer means according to the invention.

The accumulation portion 21 corresponds to a portion in which grain is accumulated and a lower portion of the accumulation portion 21 corresponds to a ventilation drying portion 22. The ventilation drying portion 22 is configured to include a plurality of ventilation path members 47 each of which is formed by a porous plate and has a mountain-shaped cross section. Upper rotary valve devices 23 are provided at a boundary between the ventilation drying portion 22 and the heating processing portion 24. The upper rotary valve devices 23 open and close between the ventilation drying portion 22 and the heating processing portion 24. A duct (not illustrated), which will be described later, is connected to the ventilation path members 47 so that hot air is supplied therethrough.

The heating processing portion 24 is formed to have a valley-shaped cross section of being narrower to the lower side. The heating processing portion 24 acts in a funnel-like manner so as to make the grain gradually flow down. With this, the nutrition enriching processing can be performed in such manner that a flow rate of the grain is limited and the grain is made to flow down from the accumulation portion 21 at a rate suitable for the nutrition enriching processing. A radiator cover 27 of which lower portion is formed by a porous member 49 is provided at a substantially center portion of the heating processing portion 24. The radiator cover 27 has a substantially rhombic cross section. A cylindrical far infrared ray radiator 33 is accommodated in the radiator cover 27. The grain which has flown down from the ventilation drying portion 22 to the heating processing portion 24 flows down through sloped flow-down paths 25 configured between the radiator cover 27 and inner walls 28. Since the radiator cover 27 has the substantially rhombic cross section, grain as a raw material flows down along outer faces without depositing on the radiator cover 27 and flows into the flow-down paths 25. The flow-down paths 25 are provided at both sides in a V shaped-form so as to surround a portion formed by the porous member 49 of the radiator cover 27. The grain is heated on the flow-down paths 25 by efficiently using far infrared rays emitted by the far infrared ray radiator 33. A width of each flow-down path 25 is approximately 100 mm. The far infrared rays do not reach to grain flowing at center portions of the flow-down paths 25. However, directions of kernels change while the grain flows down through the slope flow-down paths 25 and a stirring effect is generated on surface portions so that heating unevenness is made mild. Lower portions of the inner walls 28 are formed by porous members 29 on which a large number of holes smaller than the kernels are perforated so as to communicate with heating processing portion exhaust paths 34. The heating processing portion exhaust paths 34 are connected to the above-mentioned ventilation path members 47 with the duct (not illustrated).

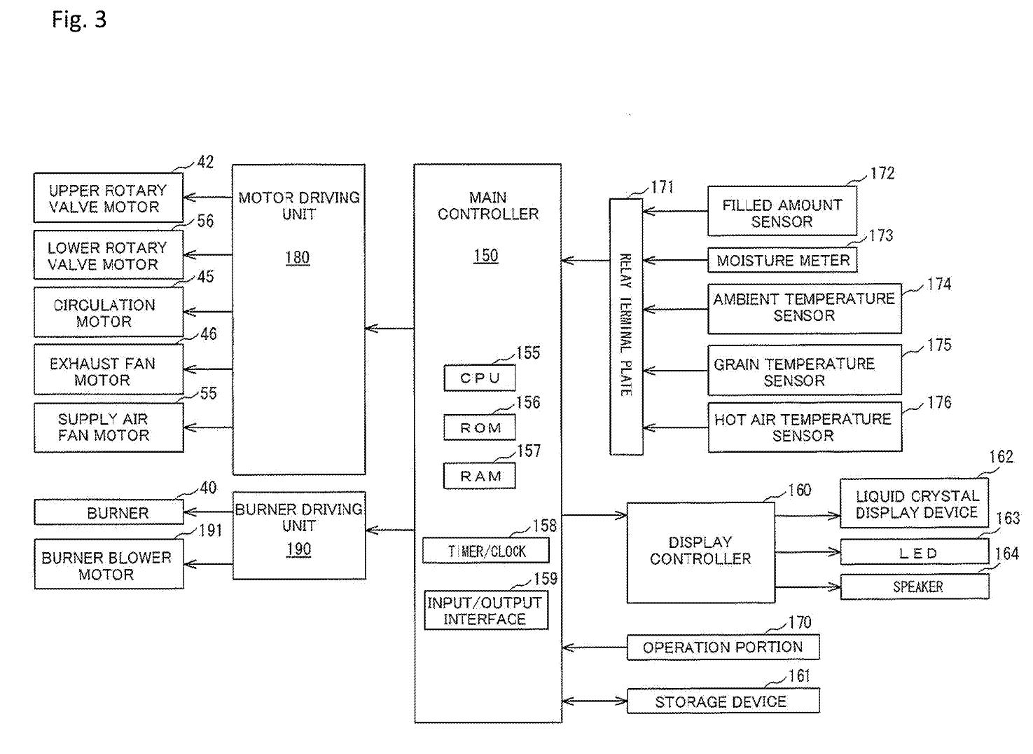

A burner 40 is mounted on one end of the far infrared ray radiator 33 and the burner 40 burns kerosene as fuel and emits flames into the far infrared ray radiator 33. In this manner, the burner 40 heats the far infrared ray radiator 33 so as to make the far infrared ray radiator 33 emit far infrared rays. A burner exhaust pipe 43 is connected to the other end of the far infrared ray radiator 33. The burner exhaust pipe 43 is connected to the duct so that burning exhaust gas in the infrared ray radiator 33 is supplied to the ventilation path members 47 therethrough. A burner blower (not illustrated) driven by a burner blower motor 191 (see, FIG. 3) is provided on the burner exhaust pipe 43 at the duct side so as to transmit exhaust gas from the burner 40 to the duct. That is to say, the exhaust gas from the burner 40 and hot air generated by the far infrared ray radiator 33 are collected to the duct through the burner exhaust pipe 43 or the heating processing portion exhaust paths 34 so as to be transmitted to the ventilation path members 47. The heating processing portion 24 corresponds to heating means according to the invention.

The kerosene as fuel of the burner 40 is accumulated in a fuel tank 70 and the fuel tank 70 and the burner 40 are connected to each other by a fuel hose 71 so that the kerosene is supplied from the fuel tank 70 to the burner 40 by a fuel pump (not illustrated). Further, although not illustrated in the drawings, an ordinary AC power supply is used for a power supply for each motor and the like.

A lower rotary valve device 37 which is driven by a lower rotary valve motor 56 is provided at a boundary between the heating processing portion 24 and the discharge portion 26. The lower rotary valve device 37 continuously rotates so as to intermittently open and close between the heating processing portion 24 and the discharge portion 26. Further, if the lower rotary valve device 37 is stopped at an opened position or a closed position, the lower rotary valve device 37 can also keep between the heating processing portion 24 and the discharge portion 26 in an opened state or a closed state. The groove-shaped discharge pit 35 is provided at a center of the bottom of the discharge portion 26 and the lower screw conveyer 38 is arranged along the lengthwise direction of the discharge pit 35. The grain which has flown into the discharge portion 26 flows into the discharge pit 35 based on gradients of sloped faces 48.

The grain which has flown into the discharge pit 35 is transported to the bucket conveyer 30 by the lower screw conveyer 38 and is transported to the upper side by the bucket conveyer 30, again. The bucket conveyer 30 has a configuration of scooping the grain with a large number of buckets attached to an endless belt and transporting the grain. Even if condensation is generated on a surface of the heated grain, the grain can be stably transported without causing a problem that the grain is firmly fixed in the bucket conveyer 30 and cannot be transferred. An inner portion of the bucket conveyer 30 is thermally insulated with rigid urethane provided at the inner side of an outer plate. The grain which has reached to an uppermost portion of the bucket conveyer 30 is transferred into the casing 20 by the upper screw conveyer 31 so as to be supplied onto a dispersion member 36 provided at a center of an upper portion of the accumulation portion 21. The dispersion member 36 rotates about a shaft in the vertical direction so as to disperse the grain into the accumulation portion 21 with a centrifugal force. The lower screw conveyer 38, the bucket conveyer 30, the upper screw conveyer 31, and the dispersion member 36 are coupled by gears, pulleys, and the like so that a driving force is transmitted thereto. The lower screw conveyer 38, the bucket conveyer 30, the upper screw conveyer 31, and the dispersion member 36 are driven by a circulation motor 45 and operate in conjunction with each other.

When grain is filled, the grain is put in the charge hopper 41 and is transported by the bucket conveyer 30. Further, when the grain is discharged, the grain is discharged to the outside of the apparatus from a thrower (not illustrated) provided on an upper portion of the bucket conveyer 30 based on an operation on an operation portion 170 (see, FIG. 3). As will described in detail later, various switches and the like are provided on the operation portion 170 and operations including grain circulation, a nutrition enriching processing, a dry processing, and the like in addition to the discharge of the grain can be performed on the operation portion 170. The operation portion 170 is arranged on an operation box 140 provided in the vicinity of a lower portion of the bucket conveyer 30 together with a liquid crystal display device 162, an LED 163, and a speaker 164 (any of them, see FIG. 3) for displaying various pieces of information for an operator.

Hereinafter, a control mechanism of the nutrition-enriched grain manufacturing apparatus 10 is described with reference to FIG. 3. A main controller 150 for controlling each part is a controller for ordinary mechanical integration, which includes a CPU 155, a ROM 156, a RAM 157, a timer/clock 158, and various input/output interfaces 159. The main controller 150 is arranged in the operation box 140. A motor driving unit 180 and a burner controller 190 are connected to the main controller 150 through the input/output interfaces 159 and instructions for controlling devices such as the motors and the burner are transmitted thereto.

A storage device 161 as a memory card reader is further connected to the main controller 150 so that the main controller 150 can read out and write information used for controlling the nutrition-enriched grain manufacturing apparatus 10, such as database of information relating to a reference moisture content. Information corresponding to breeds is accommodated in the database such that a reference moisture content of grain of which moisture content is generally high, such as corn, is higher, and a reference moisture content of grain of which moisture content is generally low, such as unhulled rice, is lower. The reference moisture content is appropriately determined in a range of 20 to 80 weight % based on the database.

The operation portion 170 is arranged in the operation box 140 as described above. Input from the operation portion 170 is transmitted to the main controller 150 through the input/output interface 159. A display controller 160 is provided in the operation box 140. The display controller 160 controls the liquid crystal display device 162, the LED 163, the speaker 164, and the like based on an instruction by the main controller 150 so as to derive various display modes to the liquid crystal display device 162, make the LED 163 emit light, or make the speaker 164 emit a warning sound or the like. The main controller 150 corresponds to heating control means and warning control means according to the invention. Further, a combination of the display controller 160, the liquid crystal display device 162, the LED 163 and the speaker 164 corresponds to warning means according to the invention.

Sensors included in the parts of the nutrition-enriched grain manufacturing apparatus 10 are connected to the main controller 150 through a relay terminal plate 171 so as to transmit various pieces of information required for control. That is to say, a filled amount sensor 172, a moisture meter 173, and a grain temperature sensor 175 are arranged in the accumulation portion 21 so as to measure a filled amount, a moisture content, and a grain temperature of the grain in the accumulation portion 21. Further, an ambient temperature sensor 174 is provided on an outer face of the casing 20 so as to measure a temperature at the outside of the casing 20. A hot air temperature sensor 176 is arranged on the duct so as to measure a temperature of hot air to be supplied to the ventilation drying portion 22 through the duct.

The motor driving unit 180 controls driving of the upper rotary valve motor 42, the lower rotary valve motor 56, the circulation motor 45, a supply air fan motor 55, and an exhaust fan motor 46. Note that the upper rotary valve motor 42 and the lower rotary valve motor 56 are stepping motors. The motor driving unit 180 controls phases of the rotary valve motors so that opening/closing states of the upper rotary valve devices 23 and the lower rotary valve device 37 can be controlled accurately.

The burner driving unit 190 controls driving of the burner 40 and the burner blower motor 191. The burner 40 includes a fuel pump, a fuel ejection device, and an ignition plug. The burner driving unit 190 controls the fuel pump, the fuel ejecting device, and the ignition plug to adjust a burning state of the burner 40.

The main controller 150 transmits an instruction to the motor driving unit 180 and the burner driving unit 190 based on information obtained from the above sensors so as to control the upper rotary valve devices 23, the lower rotary valve device 37, the upper screw conveyer 31, the lower screw conveyer 38, the bucket conveyer 30, and the burner 40, which are arranged in the heating processing portion 24. With this, feedback control is performed such that a grain temperature is a predetermined temperature.

Hereinafter, flow when nutrition-enriched grain is manufactured using the nutrition-enriched grain manufacturing apparatus 10 is described with reference to FIG. 4 and FIG. 5. At first, grain C1 which is undried and has a high moisture content is put in the filling hopper 41 after being harvested so as to start the nutrition enriching processing. That is to say, if the nutrition enriching processing is started based on an operation on the operation portion 170, the upper rotary valve devices 23 are made into closed states, the circulation motor 45 is operated, and the bucket conveyer 30, the upper screw conveyer 31, the dispersion member 36, and the lower screw conveyer 38 are operated. With this, the put grain is transported to the accumulation portion 21 so as to perform filling of the grain (filling S1).

Grain in a high-moisture state is preferable as grain used for the nutrition enriching processing. In a case of unhulled rice or brown rice, it is desirable that an average moisture content thereof is 20 to 35%. In cases of other breeds such as corn, wheat, and soy, those in the high-moisture state are appropriately used. In the cases, since a standard of a preferable moisture content is different depending on a type of grain in relation to a reference moisture content as described above. To be more specific, it is desirable that the average moisture content is 25 to 40% in the case of wheat, 30 to 80% in the case of corn, and 25 to 50% in the case of soy. However, in cases of any grains, the above desirable average moisture contents are slightly different depending on more detail differences in breeds of grains. Further, for other grains, those each having a preferable moisture content are used. As for any grains, the grains in the high-moisture state immediately after being harvested are particularly preferably used. If a moisture content of a raw material is too low, an effect obtained by the nutrition enriching processing is deteriorated. If the moisture content is made higher by hydration, time for hydration such as soaking is required. Therefore, in such a case, production efficiency is significantly deteriorated. Accordingly, it is desirable that the moisture contents of the grains are in the above ranges.

If the grain is filled in the accumulation portion 21, a filled amount is measured by the filled amount sensor 172. Further, a grain temperature and a moisture content are measured by the grain temperature sensor 175 and the moisture meter 173, respectively. In addition, an ambient temperature is measured by the ambient temperature sensor 174 (filled amount/grain temperature/moisture/ambient temperature measurement S2).

Information based on the measurement values by various sensors is displayed on the liquid crystal display device 162. Processing conditions including a processing time, a target grain temperature, and the like are acquired based on an operation on the operation portion 170 by a user in response to the information (processing condition acquirement S3). Note that the target grain temperature and the processing time can be arbitrarily determined within a range of 52 to 80° C. and 3 to 720 minutes, respectively, by a user. Further, if a type of the grain is selected, the main controller 150 suggests preferred processing conditions by displaying a recommended temperature and a recommended processing time on the liquid crystal display device 162 based on the ambient temperature and the moisture content of the grain.

Further, a predetermined reference moisture content corresponding to the processing conditions is extracted with reference to database of information relating to the reference moisture content which the storage unit 161 stores. The main controller 150 compares the measured moisture content and the reference moisture content with each other and judges whether the moisture content of the grain is higher than the reference moisture content or not (S4). For example, in a case where the processing conditions acquired at the processing condition acquirement S3 indicate that a raw material is unhulled rice, a target grain temperature is 60° C., a processing time is 30 minutes, a reference moisture content corresponding to the processing conditions is extracted. Then, the main controller 150 compares the extracted reference moisture content and the measured moisture content with each other and judges whether the moisture content of the grain is higher than the reference moisture content.

As a result of the judgment relating to the moisture content, when the moisture content is equal to or higher than the reference moisture content, a heating processing step S101 is started.

As a result of the judgment relating to the moisture content, when the moisture content is lower than the reference moisture content, moisture content shortage warning display 531 is performed. At the moisture content shortage warning display S31, warning indicating shortage of the moisture content and the degree of shortage with respect to a preferable moisture content are displayed on the liquid crystal display device 162 and soaking conditions (water temperature, soaking time) which are desirable for increasing the moisture content are taught. When a processing interruption operation is performed at a warning cancellation operation S34 by a user, judgment for the processing interruption is performed (S35). Then, the rotary valve devices 23, 37 are made into opened states and all the grain which has been filled is discharged to the outside of the apparatus. Thereafter, a stopping processing S36 of stopping the circulation motor 45 is performed to end the processing. In this case, a user can restart the nutrition enriching processing from the filling S1 after soaking is performed on the grain by referring to the previous soaking conditions to make the grain as a raw material into a state which is suitable for nutrition enrichment. When a processing continuing operation is performed at the warning cancellation operation S34, the processing is continued (S35) and the heating processing step S101 is started directly.

At the heating processing step S101, at first, the burner 40 and the burner blower motor 191 are operated (heating means operation S5). Then, the upper rotary valve devices 23 and the lower rotary valve device 37 are operated to heat grain flowing down the flow-down paths 25 with far infrared rays emitted by the far infrared ray radiator 33 (grain heating processing S6). After the grain heating processing S6 is ended, the grain which has flown down to the discharge portion 26 is taken out to the bucket conveyer 30 by the lower screw conveyer 38 and is elevated in the same manner as in the filling S1 (grain elevation S7). The elevated grain is put in the accumulation portion 21 and a grain temperature thereof is measured in the accumulation portion 21 (grain temperature measurement S8). Then, a target grain temperature set at the processing condition acquirement S3 and the measured grain temperature are compared with each other (S9). When the grain temperature is lower than the target grain temperature, processings subsequent to the grain heating processing S6 are performed again. When the grain temperature is equal to or higher than the target grain temperature, completion of heating is displayed (S10) and the heating processing step S101 is ended.

Next, the upper rotary valve devices 23 are closed (S11) and elevation of the grain is continued (S12) so that the grain is accumulated in the accumulation portion 21. At this time, the grain is stirred while the grain is transported by the lower screw conveyer 38, the bucket conveyer 30, the upper screw conveyer 31, the dispersion member 36, and the like. Therefore, heating unevenness and moisture unevenness of the grain are eliminated so that a proceeding state of the nutrition enriching processing is made uniform on the grain. An amount of the grain accumulated in the accumulation portion 21 is measured by the filled amount sensor 172. Then, when it has been judged that substantially the entire amount of the grain is accumulated in the accumulation portion 21 based on the measurement result, the accumulation step S102 is started. When the accumulation step S102 is started, a time from the start of the accumulation step S102 is measured by a timer/clock counter 158 with the start of the accumulation (accumulation start S13). The accumulation is continued until the accumulation time reaches to a predetermined time set at the processing condition acquirement S3 (S14). When the predetermined time has passed, the accumulation step S102 is ended, the rotary valve devices 23, 37 are opened (S15), and the nutrition enriching processing is ended. When the nutrition enriching processing is ended in this manner, nutrition-enriched grain C2 in which gamma aminobutyric acid has been enriched in the grain C1 is obtained.

Here, the nutrition-enriched grain manufacturing apparatus 10 is switched to a dry processing and the nutrition-enriched grain C2 is dried in a circulated manner (drying step S103) so as to obtain dried nutrition-enriched grain C3. At the drying step S103, a hot air temperature at the time of the drying operation is measured by the hot air temperature sensor 176 and the burner 40 is controlled by the main controller 150 and the ventilation drying portion 22 is vented by an air blower 44 such that the hot air temperature is approximately 40° C. The grain is circulated by the lower screw conveyer 38, the bucket conveyer 30, the upper screw conveyer 31, the dispersion member 36, the upper rotary valve devices 23, and the lower rotary valve device 37. The nutrition-enriched grain C2 is dried until the moisture content of the grain, which is measured by the moisture meter 173, becomes a moisture content suitable for storage.

Meanwhile, when grain having a moisture content lower than the reference moisture content is used as a raw material, the grain is hydrated to make the moisture content thereof higher, and then, the nutrition enriching processing is performed on the grain. That is to say, as illustrated in FIG. 5, dried grain C10 having a moisture content lower than the reference moisture content is made to absorb water in a soaking tank or the like, and then, is drained (hydration step S100) so as to obtain high-moisture grain C11. With this, the nutrition enriching processing can be performed on the high-moisture grain C11 in the same manner as the undried grain C1.

In this manner, the nutrition-enriched grain manufacturing apparatus 10 has a simple configuration without a water supply/drainage system. Further, grain is nutrition-enriched not by germination action with the hydration but by heating. Therefore, the nutrition enriching processing is completed for a relatively short time and a content of the gamma aminobutyric acid can be enriched in a site of the grain, which contains the endosperm part. The nutrition-enriched grain manufacturing apparatus 10 is controlled by the main control device 150 to operate such that a grain temperature becomes a set predetermined temperature. In this case, an operator needs not perform temperature adjustment during processes. Therefore, labor saving is realized and a risk that a grain temperature during the nutrition enriching processing is significantly varied and quality is deteriorated due to an operation error or the like can be prevented from occurring.

Further, a predetermined amount of grain which is to be subjected to the nutrition enriching processing can be previously filled in the accumulation portion 21 and the ventilation drying portion 22. Therefore, time and effort for sequentially putting the grain by an operator can be eliminated. In addition, following the nutrition enriching processing, the grain is dried in a continuous process without transferring the grain to a grain dryer. Accordingly, time and effort required for an operator is eliminated and an operation time is further made shorter.

In addition, with the nutrition-enriched grain manufacturing apparatus 10, the main controller 150 stabilizes a grain temperature during the nutrition enriching processing at a predetermined temperature so that the content of the gamma aminobutyric acid in the grain to be manufactured is stable. Further, the main controller 150 checks a moisture content and issues warning relating to whether the nutrition enriching processing can be performed or not when the moisture content is lower. Therefore, manufacturing of a product having a low content of the gamma aminobutyric acid due to shortage of the moisture content in the grain is prevented.

Further, with the nutrition-enriched grain manufacturing apparatus 10, grain is heated with far infrared rays. Therefore, heating unevenness is smaller in comparison with heating with microwave irradiation and conduction so that quality can be made stable. Moreover, the grain is not hydrated in the apparatus. Therefore, a risk that wet grain is solidified due to excess moisture and clogged in the apparatus can be prevented from occurring. This makes it possible to reduce load for maintenance.

In addition, the V-shaped flow-down paths 25 for the grain are provided so as to surround the far infrared ray radiator 33. With this, majority of emitted far infrared rays are irradiated onto the grain at close range, thereby obtaining excellent energy efficiency in the heating processing.

Further, the heating processing is performed by appropriately circulating the grain if needed. Therefore, a grain temperature can be made higher while repeatedly using one far infrared ray radiator 33. In addition, the grain is stirred with the circulation so that heating unevenness and unevenness of irradiation degree of the far infrared rays are eliminated. Accordingly, quality can be made uniform.

It is to be noted that a width of each flow-down path 25 is determined in accordance with a breed of grain to be processed, a processing capacity, and a capability of the far infrared ray radiator 33. Therefore, the width of each flow-down path 25 is not limited to that described in the embodiment and may be appropriately set in a range of approximately 50 to 130 mm.

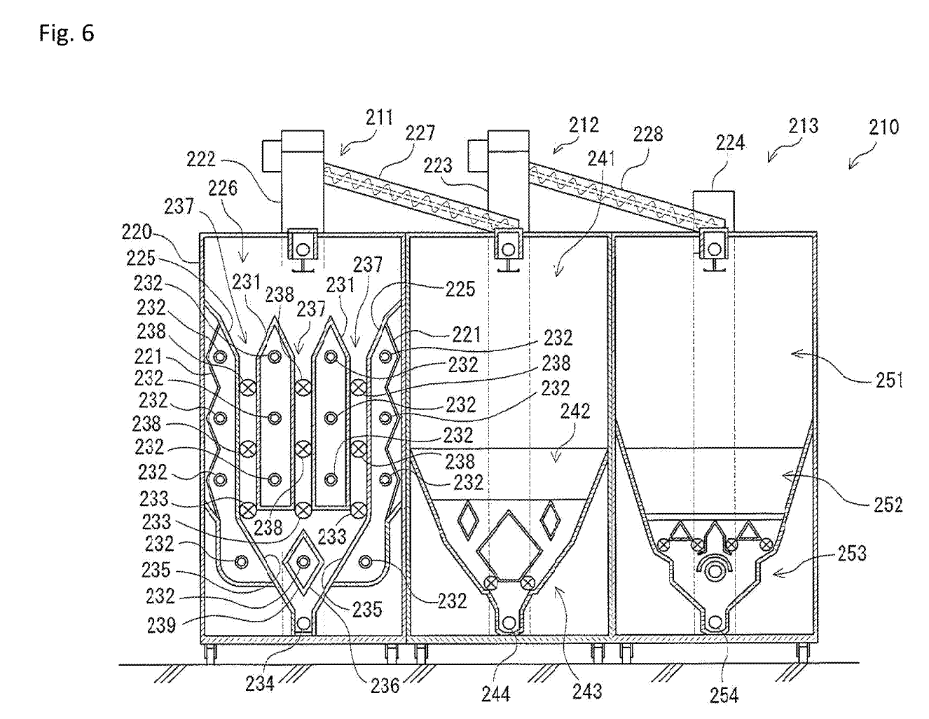

Next, a nutrition-enriched grain manufacturing apparatus 210 according to an embodiment of the invention is described with reference to FIG. 6. The nutrition-enriched grain manufacturing apparatus 210 is formed by a combination of three units of a heating processing unit 211, an accumulation drying unit 212, and a main drying unit 213. The heating processing unit 211 is a portion for heating grain. The accumulation drying unit 212 is a portion for cooling and drying the grain with air at a normal temperature of approximately 15 to 30° C. The main drying unit 213 is a portion for further drying the grain with far infrared rays and hot air. Each of the accumulation drying unit 212 and the main drying unit 213 has a configuration corresponding to an ordinary grain dryer. It is to be noted that although not illustrated in the drawing, the nutrition-enriched grain manufacturing apparatus 210 includes various sensors including a grain temperature sensor, a moisture meter, and the like, a display unit such as a liquid crystal display device and an LED, an operation portion and a main controller as in the nutrition-enriched grain manufacturing apparatus 10. Note that the heating processing unit 211 corresponds to heating means according to the invention and the main drying unit 213 corresponds to drying means according to the invention.

The heating processing unit 211 includes a first bucket conveyer 222, the accumulation drying unit 212 includes a second bucket conveyer 223, and the main drying unit 213 includes a third bucket conveyer 224 (lower portions of the first bucket conveyer 222 and the second bucket conveyer 223 are not illustrated in the drawing). A first transfer device 227 is arranged between an upper portion of the heating processing unit 211 and an upper portion of the accumulation drying unit 212. The first transfer device 227 is a screw conveyer driven by a motor (not illustrated) which operates independently of each bucket conveyer. With the first transfer device 227, grain can be transferred from the heating processing unit 211 to the accumulation drying unit 212. In the same manner, a second transfer device 228 is arranged between the upper portion of the accumulation drying unit 212 and an upper portion of the main drying unit 213. The second transfer device 228 is a screw conveyer driven by a motor (not illustrated) which operates independently of each bucket conveyer. With the second transfer device 228, grain can be transferred from the accumulation drying unit 212 to the main drying unit 213. Further, although not illustrated in the drawing, the operation portion, a fuel supply system, a power supply system, and the like are shared by the entire nutrition-enriched rice manufacturing apparatus 210.

The heating processing unit 211 has a heating processing chamber 226 in a casing 220. A plurality of radiator covers 231 each having an elongated box shape of which upper portion is pointed are arranged in the heating processing chamber 226. Electric far infrared ray radiators 232 are arranged in the radiator covers 231. Further, the far infrared ray radiators 232 are arranged at back sides of inner walls 225 in the same manner. Although not illustrated in detail in the drawing, a large number of holes which are smaller than kernels are provided on the radiator covers 231 and the inner walls 225 and far infrared rays are transmitted through the holes. An inflection member 221 is provided at an outer side of the far infrared ray radiators 232 on the back sides of the inner walls 225 so that far infrared rays emitted to the side of the casing 220 are reflected to the inner side. Grain which has been put in the heating processing chamber 226 flows down the flow-down paths 237 between the radiator covers 231 and the inner walls 225 in the substantially vertical direction. Rotary valve devices 238 for stirring are provided on the middle portions of the flow-down paths 237 so as to stir the grain which is flowing down. Rotary valve devices 233 are provided on lower ends of the flow-down paths 237 and open and close the lower ends of the flow-down paths 237 so as to change a flow-down state of the grain. Therefore, the heating processing unit 211 can heat the grain to a predetermined temperature of 52 to 80° C.

The heating processing chamber 226 has a shape of narrowing downward at a lower portion with respect to the flow-down paths 237. Further, a radiator cover 239 having a substantially rhombic cross section is arranged at a center of a lower portion of the heating processing chamber 226 and the far infrared ray radiator 232 is provided in the radiator cover 239. The far infrared ray radiators 232 are also arranged at outer sides of sloped faces 235 of the inner walls 225. A large number of holes which are smaller than kernels are also provided on the radiator cover 239 and the sloped faces 235 and far infrared rays are transmitted through the holes. A lower screw conveyer 234 is arranged at a lowermost portion of the heating processing chamber 226 and transports the grain to the first bucket conveyer 222. The first bucket conveyer 222 can switch a transfer destination of the grain to the first transfer device 227 with an adjustment valve (not illustrated).

In the accumulation drying unit 212, a ventilation drying portion 242 and a hot air drying portion 243 are provided at the lower side of an accumulation portion 241 so as to vent grain fed from the first transfer device 227 and dry the grain. Further, the nutrition enrichment can be also made to proceed with residual heat while the grain is once accumulated in the accumulation portion 241. It is to be noted that the hot air drying portion 243 can dry the grain by selecting air at a normal temperature or hot air. A lower screw conveyer 244 is arranged at a lowermost portion of the accumulation drying unit 212 and transports the grain to the second bucket conveyer 223. The second bucket conveyer 223 can switch a transfer destination of the grain to the second transfer device 228 with an adjustment valve (not illustrated).

In the main drying unit 213, a ventilation drying portion 252 and a heating drying portion 253 are provided at the lower side of an accumulation portion 251. The main drying unit 213 receives nutrition-enriched grain from which moisture has been removed from a surface and which has been cooled in the accumulation drying unit 212 from the second transfer device 228 and dries the grain for finishing. During the grain is dried, the grain is circulated by the third bucket conveyer 224 so as to operate in the same manner as an ordinary grain dryer.

When the nutrition enriching processing is performed by using the nutrition-enriched grain manufacturing apparatus 210, grain as a raw material is put from a filling hopper (not illustrated), at first, and is fed to the heating processing unit 211 by the first bucket conveyer 222. The grain fed to an uppermost portion of the heating processing chamber 226 of the heating processing unit 211 is heated by being irradiated with far infrared rays by the far infrared ray radiators 232 while flowing down the flow-down paths 237. The flowing grain is stirred by the rotary valve devices 238 so that heating unevenness and firmly fixing of kernels are eliminated. A rate at which the grain flows down the flow-down paths 237 is adjusted by the rotary valve devices 238 and the rotary valve devices 233 and a heating time of the grain is changed in accordance with the flowing rate.

The grain which has flown down to the lower side through the rotary valve devices 233 is sequentially fed from the heating processing chamber 226 by the lower screw conveyer 234 at the lowermost portion while being further heated with far infrared rays. The heating time is also adjusted by adjusting a speed at which the lower screw conveyer 234 feeds the grain.

The grain which has been heated and nutrition-enriched in the heating processing unit 211 is elevated by the first bucket conveyer 222 and fed to the accumulation drying unit 212 by the first transfer device 227. Operation switchings of the adjusting valve, which determine the feeding destination of the grain from the first bucket conveyer 222, and the first transfer device 227 are performed by checking a grain temperature and operating the operation portion for switching by an operator. It is needless to say that a controller may control the first bucket conveyer 222 and the first transfer device 227 such that the feeding destination is automatically switched based on the grain temperature.

The grain of which temperature has reached to a target grain temperature and which has been nutrition-enriched is fed to the accumulation drying unit 212 and is once accumulated therein. That is to say, the nutrition-enriched grain is accumulated in the accumulation portion 241 in a state where the accumulation drying unit 212 is stopped and is further nutrition-enriched with redundant heat. The accumulation drying unit 212 starts a drying operation after a predetermined time has passed so as to evaporate moisture on surfaces of kernels while cooling the kernels. In particular, the grain which has been heated in a high-moisture state possibly generates condensation in the cooling process but the accumulation drying unit 212 cools the grain while removing fine water droplets on the surfaces of the kernels due to the condensation. Thereafter, the nutrition-enriched grain is fed to the main drying unit 213 by the second bucket conveyer 223 and the second transfer device 228 so as to be dried to a moisture content which enables the grain to be stored for a long period of time by the main drying unit 213.

With the nutrition-enriched grain manufacturing apparatus 210, the grain is irradiated with far infrared rays from multidirections by the far infrared ray radiators 232 while stirring the grain so that the nutrition enriching processing can be efficiently performed evenly. In addition, the grain is made to flow down in the direct downward direction while gradually increasing a temperature of the grain in the flow-down paths 237 from the upper side to the lower side. Therefore, the grain is not firmly fixed easily. The grain is further prevented from being firmly fixed by stirring the grain by the rotary valve devices 238 while the grain flows down. The grain which has been subjected to the nutrition enriching processing is accumulated, and then, is cooled by ventilation in the accumulation drying unit 212 so that quality is prevented from being deteriorated.

Further, with the nutrition-enriched grain manufacturing apparatus 210, the grain is heated by the large number of far infrared ray radiators 232. Therefore, the grain can be heated to a predetermined temperature for a short time and the number of circulations of the grain in the high-moisture state is reduced, thereby reducing load on various conveyers.

Further, with the nutrition-enriched grain manufacturing apparatus 210, the nutrition enriching processing is made to proceed with residual heat in the accumulation portion 241. With this, energy efficiency can be improved in comparison with a case where the grain is continuously heated by heating means. In addition, an amount of grain which is heated per unit time is increased by transporting the grain which has been heated to the accumulation portion 241 and making the heating processing unit 211 usable continuously while the grain which has been previously heated is accumulated.

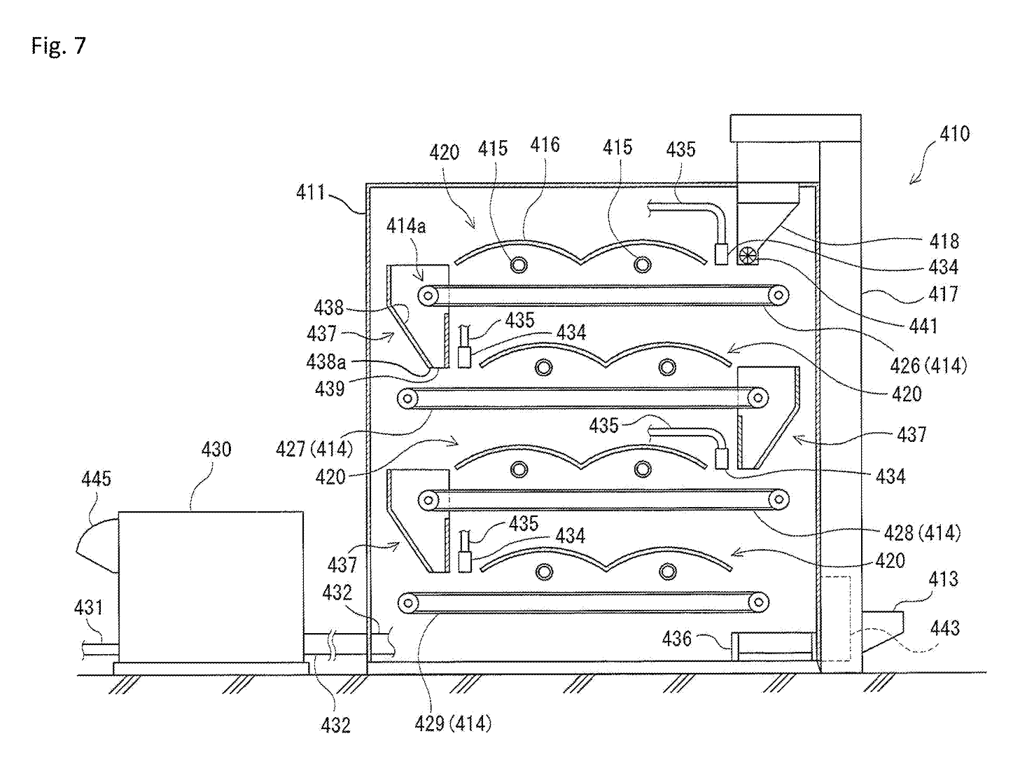

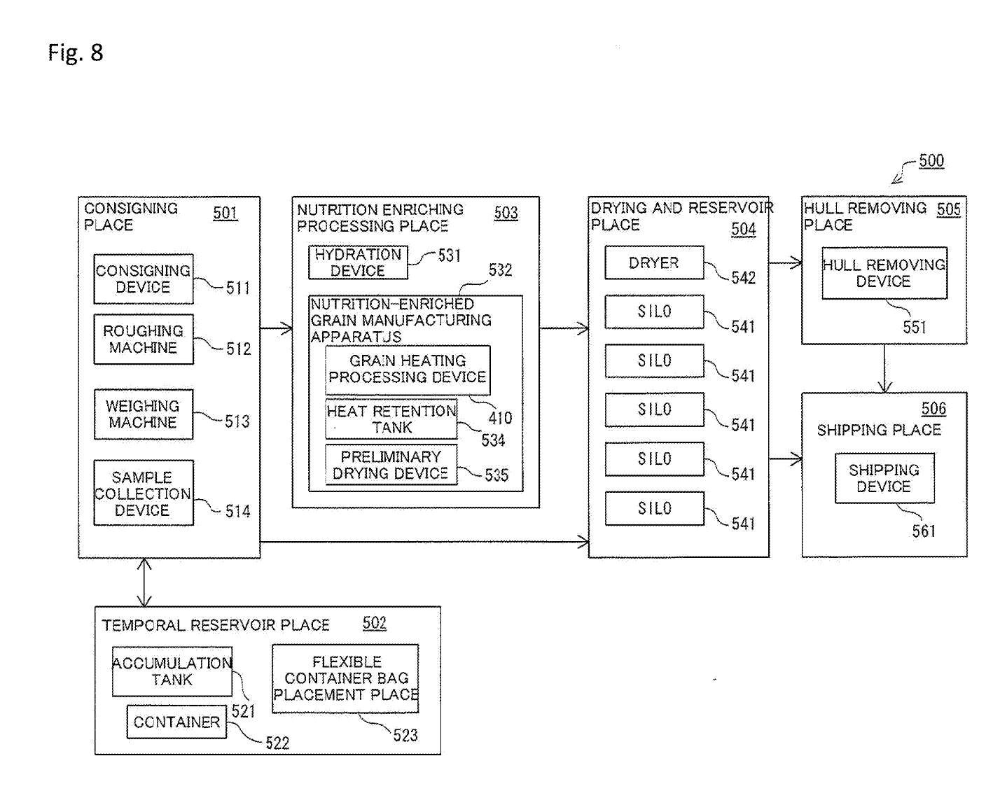

Next, a nutrition-enriched grain manufacturing apparatus 532 according to another embodiment of the invention is described with reference to FIG. 7 and FIG. 8. As illustrated in FIG. 8, the nutrition-enriched grain manufacturing apparatus 532 includes a grain heating processing device 410, a heat retention tank 534, and a preliminary drying device 535. As will be described in detail later, the nutrition-enriched grain manufacturing apparatus 532 is installed on a nutrition enriching processing place 503 of a grain drying facility 500. It is to be noted that although not illustrated in the drawings, the nutrition-enriched grain manufacturing apparatus 532 includes various sensors including a grain temperature sensor, a moisture meter, and the like, a display unit such as a liquid crystal display device and an LED, an operation portion and a main controller as in the nutrition-enriched grain manufacturing apparatus 10.

As illustrated in FIG. 7, in the grain heating processing device 410, belt conveyers 414 are arranged in a main casing 411 and grain to be transported by the belt conveyers 414 is heated with far infrared rays by far infrared ray radiators 415 and humid hot air fed from humid hot air supply ports 434 so as to be nutrition-enriched. Four belt conveyers 414 are aligned alternately in the width direction, are partially deviated in positions in the lengthwise direction, and are laterally aligned at a substantially constant interval in the vertical direction. The belt conveyers 414 transport the grain supplied onto a belt conveyer 426 at an uppermost stage from the upper side to the lower side in a switchback manner. A heating processing unit 420 including the far infrared ray radiators 415, a reflection cover member 416, and the humid hot air supply port 434 is arranged above each belt conveyer 414. Further, a bucket conveyer 417 is attached to the main casing 411. The bucket conveyer 417 transports grain as a raw material which has been put in from a charge hopper 413 to the upper side of the belt conveyer 426 at the uppermost stage. A transportation conveyer 436 is installed at the lower side of a belt conveyer 429 at a lowermost stage. The transportation conveyer 436 carries out the grain to the outside of the main casing 411 and transports the grain to the heat retention tank 534. An operation box 443 is attached on an outer face of the main casing 411 so as to be adjacent to the bucket conveyer 417. The operation box 443 has various built-in substrates such as a main controller and includes an operation switch, an LED, and the like. Note that the grain heating processing device 410 corresponds to heating means according to the invention.

Further, an air conditioner 430 which is connected to the main casing 411 with a main air supply duct 432 and a signal line (not illustrated) is installed so as to be slightly separated from the main casing 411. The air conditioner 430 incorporates an air blower, a humidifier, and a heater and supplies humid hot air at 55 to 65° C. and a relative humidity of equal to or higher than 90% to the humid hot air supply ports 434. The humid hot air supplied from the air conditioner 430 is introduced into the main casing 411 by the main air supply duct 432. Although not illustrated in the drawings, the main air supply duct 432 branches into air supply ducts 435 each of which is connected to each of the plurality of humid hot air supply ports 434. A water supply pipe 431 is connected to the air conditioner 430 so as to supply water to be used by the humidifier.

Although not illustrated in the drawings, the grain heating processing device 410 includes an exhaust fan for exhausting air in the main casing 411 to discharge a substantially equal amount of supplied humid hot air from an inner portion of the device so that an inner pressure is kept.

The belt conveyers 414 are heat-resistant belt conveyers including belts made of a metal and are driven by a motor (not illustrated) in such manner that all the belt conveyers 414 (426 to 429) are operated in conjunction with each other. Rectification hoppers 437 each of which has a cylindrical shape of which bottom side is narrower and guides grain to the subsequent belt conveyer 414 are arranged on downstream-side ends of the belt conveyers 414. Lower edges 438a of rectification plates 438 of the rectification hoppers 437 are wound around lower sides of downstream-side ends 414a of the belt conveyers 414. The grain which drops from the downstream-side ends 414a abuts against the rectification plates 438 and a direction thereof is changed. Then, the grain drop onto the belt conveyers 414 at the lower side.

Two cylindrical far infrared ray radiators 415 are arranged above each belt conveyer 414 so as to be separated from each other in the direction perpendicular to the lengthwise direction of the belt conveyer 414. The reflection cover member 416 of which bottom face is formed into a concave form is arranged above the far infrared ray radiators 415 along the lengthwise direction of each belt conveyer 414.

The grain which has been put in the charge hopper 413 is transported to an uppermost portion of the casing 411 by the bucket conveyer 417 and is fed to the supply hopper 418 above the belt conveyer 426 (414) at the uppermost stage. The supply hopper 418 receives the grain supplied from the bucket conveyer 417 and makes the grain flow down while rectifying the flow by adjusting a flow rate of the grain by the rotary valve device 441. The grain which has flown down from the bottom of the supply hopper 418 onto the belt conveyer 426 is transported in the order of the belt conveyers 426 to 429 in a switchback manner.

The grain which has been fed from the downstream side of the belt conveyer 429 at the lowermost stage is transported to the heat retention tank 534 (see, FIG. 8) by the transportation conveyer 436 which is arranged at a further lower side. The grain is accumulated in the heat retention tank 534 for approximately one hour in a state of being heat-retained so that the content of the gamma aminobutyric acid is further enriched. The grain which has been accumulated and nutrition-enriched is preliminary dried by the preliminary drying device 535 and moisture thereof is removed to the degree that the kernels are not firmly fixed due to humidity. Note that the heat retention tank 534 corresponds to an accumulation portion according to the invention and the preliminary drying device 535 corresponds to drying means according to the invention.

With the nutrition-enriched grain manufacturing apparatus 532, a heating time and a grain temperature can be adjusted by adjusting a speed of the belt conveyers 414 so as to adjust a state of the nutrition enriching processing. Further, a risk that the kernels are firmly fixing or clogged is suppressed to be low and a risk that the grain is agglomerated and a heating state is made uneven or the grain is clogged in the apparatus is prevented from occurring. Therefore, nutrition-enriched grain can be stably manufactured.

In addition, with the nutrition-enriched grain manufacturing apparatus 532, the grain is heated with humid hot air in addition to far infrared rays. This makes it possible to prevent deterioration of a nutrition enriching effect due to lowering of the moisture content of the grain.

It is to be noted that although the belt conveyers 414 including belts made of a metal have been described, the belt conveyers 414 may be made of a resin such as a fluorine resin or a rubber and have a heat resistance.

Next, the grain drying facility 500 including the grain heating processing device 410 is described with reference to FIG. 8. The grain drying facility 500 is a facility of a type which is generally called country elevator. The grain drying facility 500 includes a consigning place 501, a nutrition enriching processing place 503, a drying and reservoir place 504, a hull removing place 505, a shipping place 506, and a temporal reservoir place 502. The grain drying facility 500 dries grain such as unhulled rice, wheat, and soy and performs the nutrition enriching processing thereon.

The consigning place 501 includes a consigning device 511, a roughing machine 512, a weighing machine 513, and a sample collection device 514. The consigning device 511 is a device in which grain which has been got by a farmer is put and the grain which has been put therein is fed to the roughing machine 512 and the weighing machine 513 in this order.

The temporal reservoir place 502 includes a reservoir tank 521, a container 522, and a flexible container bag placement place 523. The reservoir tank 521 is a tank which temporarily accumulates grain and temporarily reserves undried grain in a ventilation state. The container 522 is a container dedicated for accommodating grain and has a ventilation property. The flexible container bag placement place 523 is a place in which the undried grain is temporarily reserved in a state of being put in a flexible container. A method of temporarily reserving the grain is appropriately selected in accordance with an arrival condition and the like.

The nutrition enriching processing place 503 includes the above-described nutrition-enriched grain manufacturing apparatus 532, and a hydration device 531. The hydration device 531 is a soaking tank in which grain can be soaked and includes a water supply system which can supply hot water and cool water at 0 to 60° C. When a moisture content of grain which is desired to be subjected to the nutrition enriching processing is lower than the reference moisture content, the grain is hydrated by the hydration device 531 so as to increase the moisture content, and then, the nutrition enriching processing is performed on the grain. A water temperature in the hydration device is preferably set in a temperature range in which the grain does not germinate for enhancing an effect obtained by the nutrition enriching processing. The water temperature is set in accordance with a breed of the grain. In the case of unhulled rice, a temperature range suitable for soaking is a lower temperature of 0 to 10° C. to a higher temperature of 45 to 52° C.

The drying and reservoir place 504 includes a dryer 542 and a large number of silos and dries grain. The hull removing place 505 includes a hull removing machine 551 and performs a processing of removing integument on grain which is to be shipped in a state without integument, such as unhulled rice. The shipping place 506 includes a shipping device 561 and ships a product. The silos 541, the dryer 542, the hull removing machine 551, and the shipping device 561 are equivalent to system devices which are used in an ordinary grain drying facility and a configuration of each member is not described in detail.

The grain which has been arrived at the grain drying facility 500 is conveyed to the consigning place 501 and is put in the consigning device 511. The grain is fed from the consigning device 511 to the roughing machine 512 and foreign matters and dusts are removed therefrom. Thereafter, the grain is fed to the weighing machine 513 to be weighed. Further, a small amount of grain is collected as a sample in the sample collection device 514 and a quality thereof is checked.

The grain which has been weighed and on which a consigning processing has been completed is dried for being reserved for a long period of time. However, if the arrival of grain is concentrated and an amount of the grain is beyond processing capabilities of the nutrition-enriched grain manufacturing apparatus 532 and the drying and reservoir place 504, the grain by the amount beyond the processing capabilities is temporarily reserved by being put in the reservoir tank 521 or the container 522 or being placed on the flexible container bag placement place 523 in a state of being put in the flexible container in the temporal reservoir place 502.

The grain to be subjected to the nutrition enriching processing is transferred to the nutrition enriching processing place 503 before being dried so that the nutrition enriching processing is performed on the grain in the nutrition-enriched grain manufacturing apparatus 532. That is to say, when an average moisture content of the grain is equal to or higher than the reference moisture content, the grain is heated in the grain heating processing device 410 and heat-retained in the heat retention tank 534 for a predetermined time of approximately 30 minutes to 3 hours so that the gamma aminobutyric acid content is enriched. When the average moisture content of the grain is insufficient, the grain is hydrated in the hydration device 531, and then, is subjected to the nutrition enriching processing. After the grain which has been subjected to the nutrition enriching processing has been preliminarily dried by the preliminary drying device 535 and water attached to surfaces of the kernels has been removed, the grain is transferred to the drying and reservoir place 504.

The nutrition-enriched grain which has been conveyed to the drying and reservoir place 504 is dried by the dryer 542. The dried grain is reserved in the silos 541 until shipping. Further, the grain which is not subjected to the nutrition enriching processing is conveyed from the temporal reservoir place 502 directly and dried in the same manner.

The grain which has been conveyed to the drying and reservoir place 504 is managed by a computer. That is, conditions of the grain, which include a breed of grain as a raw material, a harvesting date, a method and a processing time of the nutrition enriching processing, a processing temperature, an accumulation time, and the like, are also recorded in addition to whether the grain has been subjected to the nutrition enriching processing and these conditions are computerized so as to be referred later. With this, a content of the gamma aminobutyric acid and a degree of gelatinization of starch in the kernels are estimated so that a quality of the nutrition-enriched grain is finely managed.

The nutrition-enriched grain is taken out from the silos 541 at the time of the shipping so as to be shipped from the shipping place 506. At this time, when the grain is a breed of grain from which integument should be removed, the integument is removed from the grain in the hull removing place 505 before being shipped. That is to say, when the nutrition-enriched grain is unhulled rice, chaff is removed by removing hulls so as to obtain brown rice.

In this manner, the grain drying facility 500 includes the consigning place 501 and the drying and reservoir place 504. The grain drying facility 500 can receive a large amount of undried grain immediately after the grain has been harvested, which is suitable as a raw material of the nutrition-enriched grain, and can rapidly dry the grain after the nutrition enriching processing. Accordingly, the grain drying facility 500 is preferable for mass production of nutrition-enriched grain.

Meanwhile, grain is normally harvested in a state of being slightly dried a few days after the grain has been matured. In contrast, the grain having a higher moisture content is preferable for the nutrition enriching processing. Therefore, if the grain for the nutrition enriching processing is harvested early, the arrival time is deviated from normal harvesting of grain and concentration of the arrival can be made mild. This makes it possible to obtain a sufficient processing capability of the grain drying facility 500 so that the grain drying facility 500 can receive much more grain, thereby enhancing operation efficiency.

Immediately after the nutrition-enriched grain has been processed, the grain is transferred to the drying and reservoir place 504 so as to be dried. At this time, if the grain is transferred between a plurality of facilities so as to be delivered and received, there arises a risk that the nutrition-enriched grain and other grains are mixed during the transferring. However, with the grain drying facility 500, the grain is consistently managed in the same facility from arrival to shipping so that such mixing is not easily caused. Therefore, management cost is largely reduced and problems in manufacturing management including confusion of products and mixing of normal grain in the nutrition-enriched grain are prevented from occurring.

In addition, with the grain drying facility 500 according to the above embodiment, the moisture content of the grain as a raw material is made higher by the hydration device 531 so as to perform the nutrition enriching processing. Therefore, the dried grain can be also nutrition-enriched. Accordingly, a harvesting time is not particularly limited and nutrition-enriched grain can be manufactured throughout the year. The hydration device 531 can increase the moisture content slowly while suppressing the grain from being denatured in soaking at a low temperature. The hydration device 531 can increase the moisture content for a relatively short time even when water absorbability of the grain is low in soaking at a high temperature.

Hereinbefore, the invention has been described by using preferable embodiments. However, the invention is not limited to these embodiments. As will be described below, various improvements and changes can be made in a range without departing from a scope of the invention.

That is to say, various heat sources other than the far infrared radiator can be used in the heating means. For example, a method in which the grain is irradiated not with far infrared rays but with infrared rays having short wavelengths, or a method in which the grain as a raw material is irradiated with microwaves may be used and a method thereof is not particularly limited.

In addition, as a method of adjusting a heating state of grain by the heating means, a method of adjusting output from the far infrared radiator and a method of adjusting a heating time of grain by adjusting a conveyance speed of the belt conveyer and a rotational speed of the rotary valve device have been described in the above embodiments. However, other configurations may be employed. For example, a configuration in which a movable shielding member is arranged between the far infrared ray radiator and the grain and the shielding member is moved so as to adjust an irradiation state of far infrared rays onto the grain may be employed and a configuration is not particularly limited.

Further, in the above embodiment, the grain drying facility 500 as a country elevator has been described as an example of a grain drying facility. However, other types of grain drying facilities may be used. For example, a grain drying facility including a small-sized bin called rice center, or a rack-type grain drying facility may be used. Further, the silos are not necessarily required to be provided in the grain drying facility and a smaller grain drying facility may be used. The invention can be applied to various facilities for receiving and drying undried grain.

In the above embodiment, the grain drying facility 500 including the nutrition-enriched grain manufacturing apparatus 532 has been described. However, the nutrition-enriched grain manufacturing apparatus included in the grain drying facility may be in another form. The grain drying facility 500 may include the nutrition-enriched grain manufacturing apparatuses 10, 210 or a nutrition-enriched grain manufacturing apparatus in a further different form.

In addition, when the hydration device 531 includes a plurality of soaking tanks, a soaking tank at a low temperature and a soaking tank at a high temperature may be prepared and used in combination. With this, soaking at the low temperature and soaking at the high temperature can be performed in combination. This makes it possible to make a soaking time shorter while preventing the quality from being deteriorated.

What is claimed is:

1. A nutrition-enriched grain manufacturing apparatus comprising:
heating means for heating grain;
an accumulation portion which has a heat retention function of accumulating the grain heated by the heating means in a state of being heat-retained;
drying means for drying the grain which has been accumulated in the accumulation portion; and
main control means for controlling the heating means such that a grain temperature is a predetermined temperature set to be equal to or higher than 52° C. and equal to or lower than 80° C. based on measurement by a grain temperature sensor which measures the grain temperature of the grain to perform a nutrition enriching processing of enriching a content of gamma aminobutyric acid in the grain, controlling a time during which the heated grain is accumulated in the accumulation portion based on measurement by means for measuring a time to control such that the nutrition enriching processing of enriching the content of the gamma aminobutyric acid in the grain is performed with residual heat for a predetermined time, and controlling the drying means to dry the grain which has been subjected to the nutrition enriching processing,
wherein the accumulation portion is provided at a downstream side in a transfer direction of the grain with respect to the heating means and the drying means is provided at a downstream side in the transfer direction with respect to the accumulation portion, and a non-circulated system in which the grain is not transferred from the drying means to the heating means is employed, and
the heating means is means for heating the grain in a space in which a blower and an air exhaust device are not provided or means for heating the grain in a space to which humid hot air is supplied from a humid hot air supply port.

2. The nutrition-enriched grain manufacturing apparatus according to claim 1, further including a ventilation drying portion which is provided in a space of the accumulation portion and dries the grain by ventilation,
wherein the main control means controls the ventilation drying portion such that the ventilation drying portion is not operated while the nutrition enriching processing is performed with residual heat by accumulating the grain in the accumulation portion for a predetermined time and is started to be operated after the predetermined time has passed to dry the grain in the accumulation portion.

3. The nutrition-enriched grain manufacturing apparatus according to claim 1,
wherein the heating means includes a plurality of conveyers which transport the grain into a space in which the grain is heated, and
the plurality of conveyers are arranged at upper and lower sides in a state where ends of the conveyers in a lengthwise direction are deviated in positions from each other and transport the grain by dropping the grain from the end of the conveyer at the upper side to the conveyer at the lower side.

4. The nutrition-enriched grain manufacturing apparatus according to claim 2,
wherein the heating means includes a plurality of conveyers which transport the grain into a space in which the grain is heated, and
the plurality of conveyers are arranged at upper and lower sides in a state where ends of the conveyers in a lengthwise direction are deviated in positions from each other and transport the grain by dropping the grain from the end of the conveyer at the upper side to the conveyer at the lower side.

5. The nutrition-enriched grain manufacturing apparatus according to claim 1, further including:
storage means for storing a predetermined reference moisture content;
a moisture meter which measures a moisture content of the grain before a nutrition enriching processing, and
warning means for issuing warning indicating that the moisture content of the grain is lower,
wherein the main control means controls a moisture content checking processing of comparing the measured moisture content and the reference moisture content with each other and making the warning means issue the warning when the moisture content is lower than the reference moisture content.

6. The nutrition-enriched grain manufacturing apparatus according to claim 2, further including:
storage means for storing a predetermined reference moisture content;
a moisture meter which measures a moisture content of the grain before a nutrition enriching processing, and
warning means for issuing warning indicating that the moisture content of the grain is lower,
wherein the main control means controls a moisture content checking processing of comparing the measured moisture content and the reference moisture content with each other and making the warning means issue the warning when the moisture content is lower than the reference moisture content.

7. The nutrition-enriched grain manufacturing apparatus according to claim 3, further including:
storage means for storing a predetermined reference moisture content;
a moisture meter which measures a moisture content of the grain before a nutrition enriching processing, and
warning means for issuing warning indicating that the moisture content of the grain is lower,
wherein the main control means controls a moisture content checking processing of comparing the measured moisture content and the reference moisture content with each other and making the warning means issue the warning when the moisture content is lower than the reference moisture content.

8. The nutrition-enriched grain manufacturing apparatus according to claim 4, further including:
storage means for storing a predetermined reference moisture content;
a moisture meter which measures a moisture content of the grain before a nutrition enriching processing, and
warning means for issuing warning indicating that the moisture content of the grain is lower,
wherein the main control means controls a moisture content checking processing of comparing the measured moisture content and the reference moisture content with each other and making the warning means issue the warning when the moisture content is lower than the reference moisture content.

9. A grain drying facility comprising:
the nutrition-enriched grain manufacturing apparatus according to claims 1;
a temporal reservoir place in which undried grain is reserved; and
a drying and reservoir place in which the grain which has not been dried or the grain which has been subjected to the nutrition enriching processing by the nutrition-enriched grain manufacturing apparatus is dried and the grain which has been dried is reserved.

10. A grain drying facility comprising:
the nutrition-enriched grain manufacturing apparatus according to claims 2;
a temporal reservoir place in which undried grain is reserved; and
a drying and reservoir place in which the grain which has not been dried or the grain which has been subjected to the nutrition enriching processing by the nutrition-enriched grain manufacturing apparatus is dried and the grain which has been dried is reserved.

11. A grain drying facility comprising:
the nutrition-enriched grain manufacturing apparatus according to claims 3;
a temporal reservoir place in which undried grain is reserved; and
a drying and reservoir place in which the grain which has not been dried or the grain which has been subjected to the nutrition enriching processing by the nutrition-enriched grain manufacturing apparatus is dried and the grain which has been dried is reserved.

12. A grain drying facility comprising:
the nutrition-enriched grain manufacturing apparatus according to claims 4;
a temporal reservoir place in which undried grain is reserved; and
a drying and reservoir place in which the grain which has not been dried or the grain which has been subjected to the nutrition enriching processing by the nutrition-enriched grain manufacturing apparatus is dried and the grain which has been dried is reserved.

13. A grain drying facility comprising:
the nutrition-enriched grain manufacturing apparatus according to claims 5;
a temporal reservoir place in which undried grain is reserved; and
a drying and reservoir place in which the grain which has not been dried or the grain which has been subjected to the nutrition enriching processing by the nutrition-enriched grain manufacturing apparatus is dried and the grain which has been dried is reserved.

14. A grain drying facility comprising:
the nutrition-enriched grain manufacturing apparatus according to claims 6;
a temporal reservoir place in which undried grain is reserved; and
a drying and reservoir place in which the grain which has not been dried or the grain which has been subjected to the nutrition enriching processing by the nutrition-enriched grain manufacturing apparatus is dried and the grain which has been dried is reserved.

15. A grain drying facility comprising:
the nutrition-enriched grain manufacturing apparatus according to claims 7;
a temporal reservoir place in which undried grain is reserved; and
a drying and reservoir place in which the grain which has not been dried or the grain which has been subjected to the nutrition enriching processing by the nutrition-enriched grain manufacturing apparatus is dried and the grain which has been dried is reserved.

16. A grain drying facility comprising:
the nutrition-enriched grain manufacturing apparatus according to claims 8;
a temporal reservoir place in which undried grain is reserved; and
a drying and reservoir place in which the grain which has not been dried or the grain which has been subjected to the nutrition enriching processing by the nutrition-enriched grain manufacturing apparatus is dried and the grain which has been dried is reserved.
